(19) United States
(12) Patent Application Publication
(10) Pub. No.: US 2026/0040096 A1
(43) Pub. Date: Feb. 5, 2026

(54) METHOD AND APPARATUS FOR AI MODEL DEFINITION AND AI MODEL TRANSFER

(71) Applicant: Apple Inc., Cupertino, CA (US)

(72) Inventors: Huaning Niu, San Jose, CA (US); Haijing Hu, Los Gatos, CA (US); Dawei Zhang, Saratoga, CA (US); Vivek G Gupta, San Jose, CA (US); Wei Zeng, Saratoga, CA (US); Oghenekome Oteri, San Diego, CA (US); Weidong Yang, San Diego, CA (US); Peng Cheng, Beijing (CN)

(21) Appl. No.: 18/997,013

(22) PCT Filed: Jul. 28, 2023
(86) PCT No.: PCT/US2023/028913

§ 371 Date: Jan. 18, 2025

Related U.S. Application Data
(60) Provisional application No. 63/394,270, filed on Aug. 1, 2022.

(51) Int. Cl. H04W 24/02; G06N 3/0455

(52) U.S. Cl. CPC H04W 24/02; G06N 3/0455

(57) ABSTRACT

An apparatus of a user equipment (UE), the apparatus comprising a processor, and a memory storing instructions that, when executed by the processor, configure the apparatus to receive, from a base station of an operator network, Protocol Data Units (PDUs) carrying Artificial Intelligence (AI) model data in either a control plane or a user plane, and decapsulate the PDUs to obtain and store the AI model data, wherein the AI model data is indicative of an AI model configured for inference in Access Network (AN) protocol layers at the UE.

### TECHNICAL FIELD

The present application relates generally to wireless communication systems, including defining and supporting transfer of Artificial Intelligence (AI) or Machine learning (ML) model, for example, in 5G communication system.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to some embodiments of the present application.

FIG. 2 illustrates a system for performing signaling between a wireless device and a network device, according to some embodiments of the present application.

FIG. 3 shows a general structure of the auto-encoder/decoder-based CSI feedback.

FIG. 4 illustrates AI model data defined according to some embodiments of the present application.

FIG. 5 shows a non-roaming reference architecture for a 5G NR system.

FIGS. 6-17 show flowcharts illustrating the model transfer according to some embodiments of the present application.

FIG. 18 is a flowchart diagram illustrating an example method performed at the UE according to some embodiments of the present application.

FIG. 19 is a flowchart diagram illustrating an example method performed at the base station according to some embodiments of the present application.

### DETAILED DESCRIPTION

Application of AI/ML to the wireless communication systems has gained tremendous interest in academic and industry research in recent years. On the one hand, the network may have different deployments, such as indoor, Umi or Uma deployment, different number of antennas deployed in the cell, a single TRP (sTRP) or multiple TRPs (mTRP), and thus a number of AI models may be trained to enable flexible adaptive codebook design and to optimize the system performance. On the other hand, the UE may have different individual AI capability, or memory limitation, and thus a number of AI models may be trained to adapt to UE differentiation. Therefore, definition of these AI models is an issue to be considered.

In addition, considering collaborations between the network and UE, various levels of collaboration may be defined and identified. For example, the collaborations levels may be defined as no collaboration, signaling-based collaboration without model transfer, signaling-based collaboration with model transfer, and the like. The signaling-based collaboration with model transfer includes one sided model or two sided model trained by different vendors and stored at different locations.

For example, an AI model may be trained at the network side, for example, by the network device vendor and stored and requested from a server of the network device vendor. In this case, the AI model may need to be downloaded to the UE for inference at the UE. An AI model may also be trained at the UE side, for example, by the UE vendor and stored and requested from a server of the UE vendor. Then, the AI model may need to be uploaded to the base station for inference at the base station side. Furthermore, a two sided AI model may be trained and stored by both the base station and the UE or a 3^{rd} party, and two parts of the AI model may be transferred to the UE and the base station for inference, respectively.

Thus, depending on where the AI model is trained, i.e., where the intelligence is, its model file may be stored in a vendor server, a 3^{rd} party host, or the operator network. Depending on where the inference is performed, UE-base station collaboration over the air may be required, in order to achieve proper and efficient model transfer.

Accordingly, the present disclosure relates to various aspects of AI model definition and AI model transfer.

Various illustrative embodiments of the present application will be described hereinafter with reference to the drawings. For purpose of clarity and simplicity, not all features are described in the specification. Note that, however, many settings specific to the implementations can be made in practicing the embodiments of the present application. In addition, it should be noted that in order to avoid obscuring the description, some of the figures illustrate only steps of a process and/or components of a device that are closely related to the technical solutions of the present application, while in some other figures, well-known process steps and/or device structures are shown for only better understanding of the present application.

For convenient explanation, various aspects of the present application will be described below in the context of the 5G NR. However, it should be noted that this is not a limitation on the scope of application of the present application, and one or more aspects of the present application can also be applied to wireless communication systems that have been commonly used, such as the 4G LTE/LTE-A, or various wireless communication systems to be developed in future. Equivalents to the architecture, entities, functions, processes and the like as described in the following description may be found in these communication systems.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

Moreover, various embodiments are described with regard to a “base station”. However, reference to a base station is merely provided for illustrative purposes. The term “base station” as used in the present application is an example of a control device in a wireless communication system, with its full breadth of ordinary meaning. For example, in addition to the gNB specified in the 5G NR, the “base station” may also be, for example, a ng-eNB compatible with the NR communication system, an eNB in the LTE communication system, a remote radio head, a wireless access point, a relay node, a drone control tower, or any communication device or an element thereof for performing a similar control function.

### System Overview

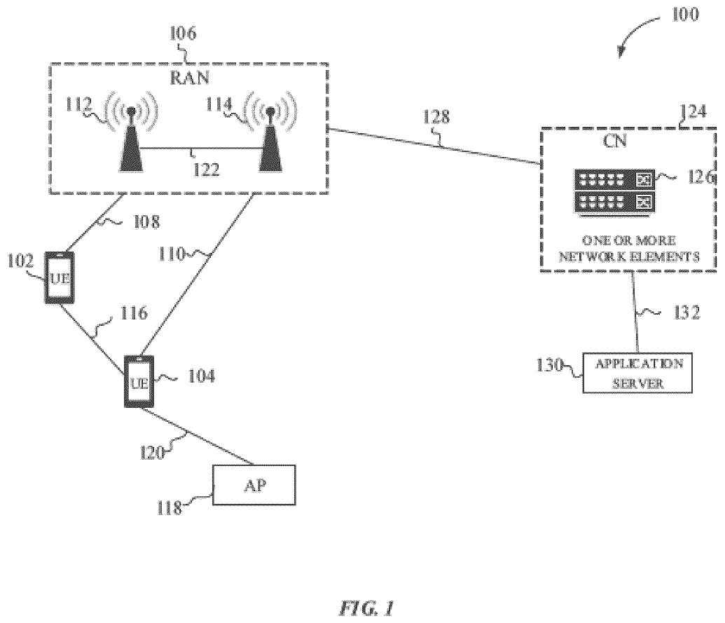

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to the 5GC, between a base station 112 (e.g., a gNB) connecting to 5GC and an eNB, and/or between two eNBs connecting to the 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

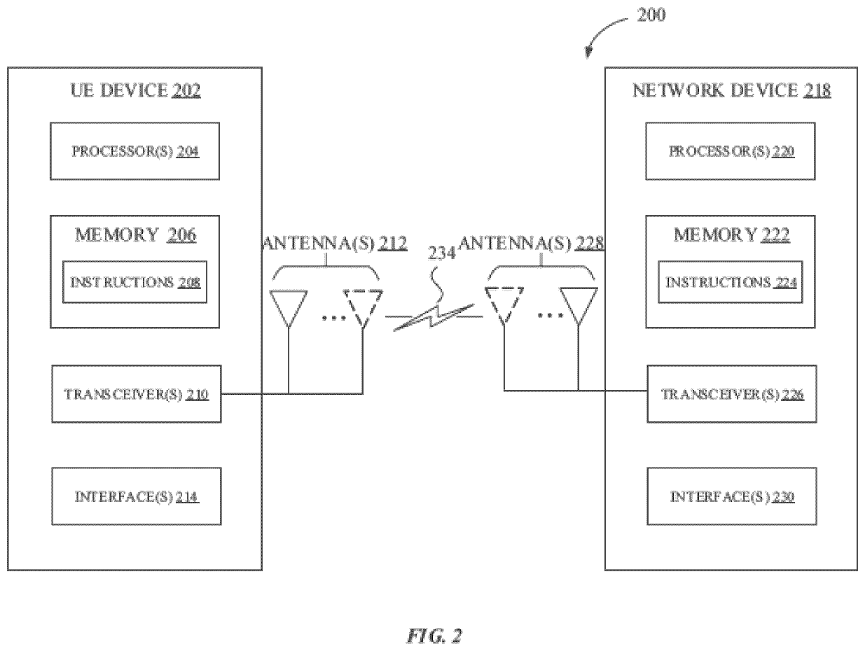

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### Considerations for Model Transfer

There are increasing discussions in the application of AI/ML to wireless communication systems. AI provides a machine or system with ability to simulate human intelligence and behavior. ML may be referred to as a sub-domain of AI research. In some instances, the AI and ML terms may be used interchangeably. A typical implantation of AI/ML is neural network (NN), such as Conventional Neural Network (CNN), Recurrent/Recursive neural network (RNN), Generative Adversarial Network (GAN), or the like. The following description may take the neural network as example of AI/ML model, however, it is understood that the AI/ML model discussed here may be not limited thereto, and any other model that performs inference on UE side or network side is possible.

Air interface design may be augmented with features enabling improved support of AI/ML based algorithms for enhanced performance and/or reduced complexity/overhead. Enhanced performance depends on use cases under consideration and could be, e.g., improved throughput, robustness, accuracy or reliability, etc. For example, the use cases may include:
channel state information (CSI) feedback enhancement, e.g., overhead reduction, improved accuracy, prediction or the like;
beam management, e.g., beam prediction in time, and/or spatial domain for overhead and latency reduction, beam selection accuracy improvement, or the like; and
positioning accuracy enhancements for different scenarios including, e.g., those with heavy Non-Line of Sight (NLOS) conditions.

Currently the use cases are explored in underlying physical (PHY) layer, but there is a possibility to expand the use cases to processing in upper layers, such as medium access control (MAC) layer, radio resource control (RRC) layer, and the like. It is expected that AI models may be trained for various use cases, possibly by UE vendors, network device vendors, network operators, 3rd party solution providers, and the like.

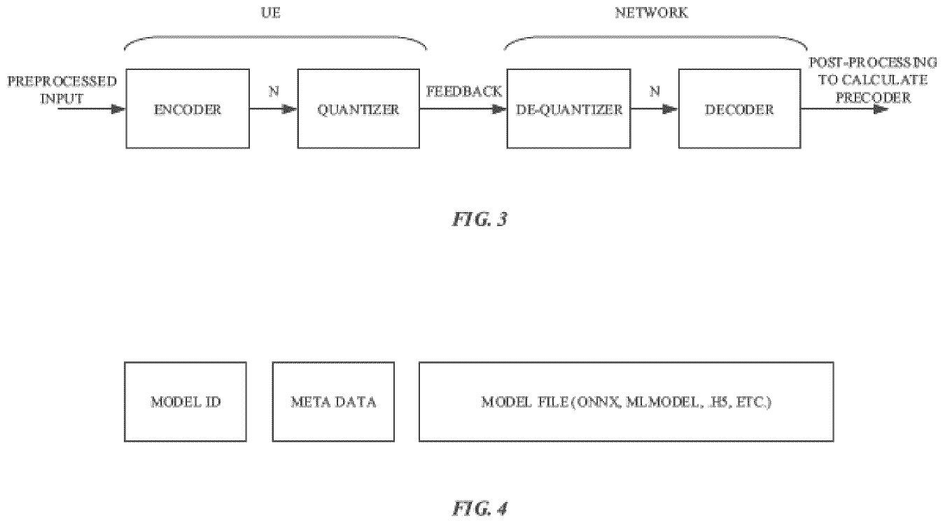

For purpose of illustration, the use case of CSI feedback enhancement is described here. Massive multiple-input multiple-output (MIMO) systems rely on channel state information (CSI) feedback to perform precoding and achieve performance gain. However, the huge number of antennas in MIMO systems leads to excessive CSI feedback overhead and poses a challenge to conventional CSI feedback overhead reduction methods. Auto-encoder/decoder-based CSI feedback enhancement is an example of an approach for addressing this challenge. FIG. 3 shows a general structure of the auto-encoder/decoder-based CSI feedback. As shown in FIG. 3, on the UE side, preprocessed CSI input is encoded by an encoder which may be an AI model, and quantized by a quantizer, and then is transmitted to the network. On the network side, the CSI feedback is dequantized by a de-quantizer, and decoded by a decoder which may also be an AI model, so as to calculate a precoder.

The auto-encoder/decoder-based approach preferably trains the overall encoder and decoder NN by deep learning, so as minimize the overall loss function of the decoder output versus the encoder input. The encoder/decoder training is centralized, while the inference function is split between UE and NG-RAN node (e.g., gNB), that is, encoder inferencing is at the UE, and decoder inferencing is at the gNB. To achieve this, UE-gNB collaboration with model transfer over the air may be required.

In this example, the NN including both of the encoder and the decoder is a two-sided model. If the NN is trained and owned at the network side, for example, by the network device vendor, a part of the NN (i.e., the auto-encoder for inference at the UE) needs to be downloaded to the UE. If the NN is trained and owned at the UE side, for example, by the UE vendor, a part of the NN (i.e., the auto-decoder for inference at the gNB side) needs to be uploaded to the gNB. Furthermore, the NN may be trained and owned by a 3^{rd} party, and two parts of the NN need to be transferred to the UE and the gNB, respectively.

Alternatively, the auto-encoder or the auto-decoder may be trained separately as a one-sided model. For example, the UE vendor may train only the encoder NN based on downlink measurement data in different cells, and the network device vendor may train only the decoder NN based on uplink data for different UEs. In this case, the UE and the gNB may acquire respective NNs from a server of the UE vendor and a server of the network device vendor, respectively.

On the one hand, the network may have different deployments, such as indoor, Umi or Uma deployment, different number of antennas deployed in the cell, a single TRP (sTRP) or multiple TRPs (mTRP), and thus a number of NNs may be trained to enable flexible adaptive codebook design and to optimize the system performance. On the other hand, the UE may have different individual AI capability, or memory limitation, and thus a number of NNs may be trained to adapt to UE differentiation. Therefore, definition of these AI models is an issue to be considered.

Moreover, depending on where the AI model is trained, i.e., where the intelligence is, its model file may be stored in a vendor server, a 3^{rd} party host, or the operator network. There is a need for model transfer to UE or gNB, depending on where the inference is performed.

### Definition of AI Model

As explained above, there may be several AI models (e.g., NNs) available to the UE or the gNB, which may be trained by different entities. The UE or the gNB may receive a plurality of different models, and store them in local memory. One of these models may be activated for use as appropriate. For example, the network may activate, deactivate or switch the AI model at the UE via signaling. Alternatively, the UE may select the AI model to be used, and inform the network of its selection.

A unique ID can be assigned to each of the AI models. The ID is used to identify the AI model unambiguously, for example, within a Public Land Mobile Network (PLMN) or among several PLMNs.

According to an embodiment of the present application, the AI model ID may include one or more of:
network device vendor identification,
UE vendor identification,
PLMN ID,
use case ID,
number of the AI model for this use case.

The network device vendor identification represents the network vendor which has trained the AI model, and the UE vendor identification represents the UE vendor which has trained the AI model. The PLMN ID represents the operator network in which the AI model is applied. In addition, the use case ID represents the use case to which the AI model is directed, and optionally, if there is more than one AI model for a particular use case, the number of the AI model for this use case is used to discriminate them. It is understood that, not all of the above items are necessary or are available at present. The definition of the AI model ID may be specific to the operator network for local discrimination, or may be provided in a specification for global discrimination.

The AI model may be stored and transferred as model data, which includes the model file in association with the AI model ID and metadata. The metadata is generated to describe respective AI model, and may indicate various information regarding the AI model, including but not limited to:
training status: trained and tested network, and potential training data set indication of the AI model;
functionality/object, input/output of the AI model;
latency benchmarks, memory requirements, accuracy of the AI model;
compression status of the AI model;
inferencing/operating condition: Urban, indoor, dense macro;
pre-processing and post-processing of the measurement for AI input/output.

The model file contain model parameters for constructing the AI model. In the case of deep neural network, the model file may include layers and weights/bias of the neural network. The model is saved in a file depending on the machine learning framework that is used. For example, a first machine learning framework may save a file in a first format, while a second machine learning framework may save a file in a different format to represent ML models.

Due to diverse model formats in current AI industry, it is expected that the model trained by different vendors can have different formats. The model file may need reformatting before, during or after it is transferred to the UE or the gNB. Assuming that the AI model is stored in a first format after being trained, but the UE or the gNB may support a second format different from the first format, then a format conversion is required. As an example, the server storing the model may convert the model file format to the second format before transmitting the model. As another example, a network function (NF) in the core of the operator network may convert the model file format before forwarding the model to the gNB. As yet another example, the gNB may take the responsibility to convert the format of the model destined for the gNB or for the UE, in latter case, the gNB then forwards the reformatted model to the UE. As yet another example, it is the UE that converts the model file format according to the UE's support capability.

The AI model data may be compressed for storage and/or transfer, for example, by using standard compression methods provided in ISO-IEC 15938-17 or any other possible compression methods, which will not be described here in detail.

### Model Transfer

Embodiments of the present application are provided to support transfer of the AI model from its storage location to the UE or gNB where it performs inference. For one-sided model, the entire model is transferred, while for two-sided model, only a part of the model is transferred, like in the example of FIG. 3, the encoder part of the neural network is transferred to the UE, and the decoder part of the neural network is transferred to the gNB. In context of the present application, the AI model to be transferred covers the cases of the one-side model and the two-sided model.

Although conventional Over the Top (OTT) solution may be employed, the model transfer in the scenarios described herein may use alternative methods for at least the following reason. In the OTT solution, the model data is transmitted as application-layer data through a tunnel provided by the operator network, the UE or gNB receives and decapsulates protocol data units (PDUs) carrying the model data, and forwards the model data to its application layer. However, the AI model according to the present application is not application-layer data, but is configured for use in lower layers, such as the PHY layer, and thus needs not to be forwarded to the application layer. In addition, the gNB and the UE both need to be aware of the AI model, so that they can perform inference jointly and life cycle management of the AI model. The OTT solution is transparent to the NR network, and prevents UE&gNB joint AI operation to happen.

The embodiments of AI model transfer according to the present application will be described below with reference to figures.

1) Model Transfer from Outside of Operator Network

The UE vendor, network device vendor or 3rd party that has trained the AI model may deploy the AI model data in its server (hereinafter referred to as “model server”). The model server is outside of the operator network. In this case, the AI model data may be transferred to the UE or gNB via a core network and a RAN.

A core network such as 5GC is the brain of the operator network and is responsible for managing and controlling the entire network. The 5GC adopts a service-based architecture, so as to realize “a single function of multiple network elements”. By means of Network Function Virtualization (NFV), the 5GC provides network functions over underlying hardware and software resources. FIG. 5 shows a non-roaming reference architecture for a 5G NR system.

The RAN of 5G NR consists of a set of gNBs connected to the 5GC through the NG interface. gNB can support FDD mode, TDD mode or dual mode operation. gNBs can be interconnected through the Xn interface. A gNB may consist of a gNB central unit (CU) and one or more gNB distribution units (DUs). A gNB-CU and a gNB-DU is connected via F1 interface. One gNB-DU is connected to only one gNB-CU. In addition, the gNB-CU may have an architecture for separation of gNB-CU-CP (control plane) and gNB-CU-UP (user plane), which can be interconnected through E1 interface.

The UE performs the uplink and downlink transmissions with the gNB via air interface based on Access Network (AN) protocol layers. The AN protocol layers include the PHY layer as Layer 1, the MAC sublayer, a radio link control (RLC) sublayer and a packet data convergence protocol (PDCP) as Layer 2, in both of the control plane and the user plane. The AN protocol layers further include a service data adaptation protocol (SDAP) sublayer in the user plane, and the RRC layer in the control plane. The AN protocol layers are terminated at the gNB on the network side, and terminated at the UE on the user side. These sublayers have the following relationship: the PHY layer provides transmission channels for the MAC sublayer, the MAC sublayer provides logical channels for the RLC sublayer, the RLC sublayer provides RLC channels for the PDCP sublayer, and the PDCP sublayer provides radio bearers for the SDAP sublayer.

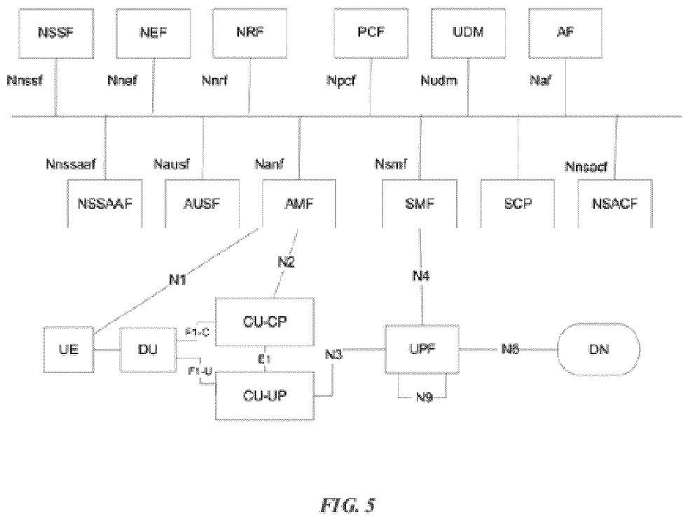

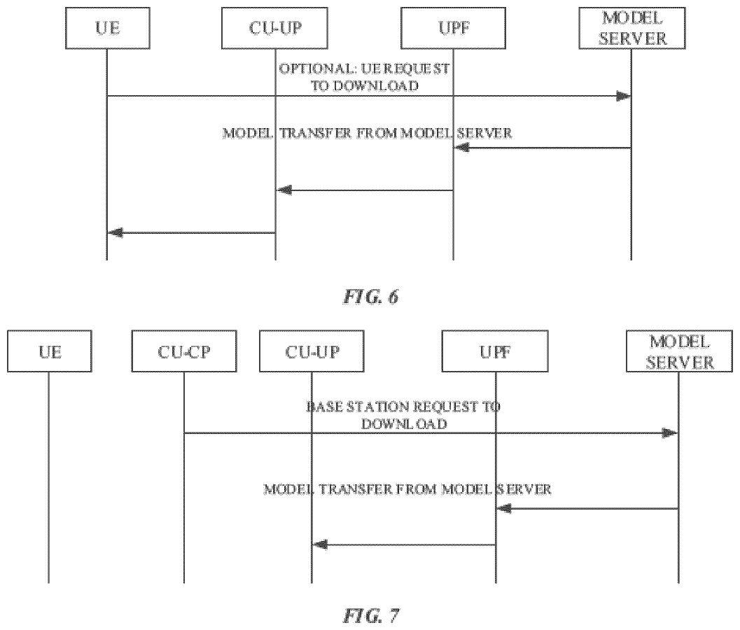

FIG. 6 and FIG. 7 show flowcharts illustrating a first aspect of the model transfer from the model server according to the present application. The model server may be a server of the UE vendor, the network device vendor or a 3rd party external to the operator network, and may store one or more AI models (e.g., neural networks) for inference at the UE or at the gNB. The model transfer is implemented in the user plane of the core network and the access network.

FIG. 6 shows a flowchart of the model transfer to the UE according to the first aspect. As shown in FIG. 6, the model transfer may be triggered by a request from the UE to download the AI model. The CU-CP of a serving gNB of the UE forwards the request to an access and mobility management function (AMF) in the 5GC, which can provide functions such as NAS security, idle-state mobility management, access authentication and authorization, and the like. The AMF forwards the request to a session management function (SMF), which can provide functions such as session management, UE IP address allocation and management, PDU session control, and the like. If there is not an available PDU session between the UE and the model server, the SMF may establish one. Furthermore, the SMF locates a user plane function (UPF) for establishing a user plane connection of the PDU session. The UPF can provide functions such as mobility anchoring, PDU processing, packet routing and forwarding, and the like, and communicates with the RAN via a N3 interface and communicates with data network (DN) via a N6 interface. The UPF is directly controlled and managed by the SMF, and executes service flow processing according to various policies issued by the SMF. The UE request is transmitted to the model server through the established PDU session.

Alternatively, the request to download the AI model may also be triggered by the gNB (not shown in FIG. 6). For example, the CU-CP of the gNB sends the request to the 5GC. If there is not an available PDU session between the gNB and the model server, the request may trigger the SMF to establish one. In this case, it is the gNB that selects the AI model to be configured for use at the UE, for example, as a result of taking factors on the network side into account. In particular, the request specifies the UE as a destination of the model download.

In response to the request, whether from the UE or the gNB, the model server may retrieve the AI model data stored therein, wherein the AI model data may include the AI model ID, the metadata and the model file as described with reference to FIG. 4. Optionally, the model server may convert the AI model file to a format that is applicable to the UE, for example, based on relevant information in the request. The model server may encapsulate the AI model data in proper PDUs for transfer to the operator network.

According to the first embodiment, the model transfer is implemented in the user plane of the core network and the access network. Specifically, the model server transmits the AI model data to the UPF of the 5GC via the N6 interface. The UPF is responsible for packet routing and forwarding of the PDUs. The UPF may also performs 5G user plane encapsulation and/or GTP-U (user plane part of GPRS Tunnel Protocol) encapsulation, so that the AI model data may be forwarded to the gNB via the N3 interface and optionally N9 interface. Differently for the OTT transmission, the UPF needs to use a proper packet flow description to mark the flow since the AI model data is not application-layer data. Optionally, the UPF may be additionally enabled to convert the format of the AI model file to that supported by the UE.

As shown in FIG. 6, the CU-UP of the gNB receives the AI model data, and relays it to the UE via Physical Downlink Shared Chanel (PDSCH). The AN protocol layers operate between the gNB and the UE. In terms of the SDAP sublayer, the CU-UP may perform proper Quality of Service (QOS) mapping and Data Radio Bearer (DRB) assignment, so that the UE after decoding the PDSCH, will not forward the packets to the application layer.

On the UE side, the UE may decapsulate the PDUs in the AN protocol layers to obtain the AI model data. The UE may store the obtained AI model data locally, for example, in a memory of its modem (modulator-demodulator). For example, the AI model may be activated in response to signaling from the gNB and used to configure the modem for inference of corresponding use case, such as the CSI feedback enhancement, the beam management, the positioning accuracy enhancement, or the like.

FIG. 7 shows a flowchart of the model transfer to the gNB according to the first aspect. As shown in FIG. 7, the model transfer may be triggered by a request from the gNb to download the AI model. The transmission of the request to the model server may be similar to the description above. The request specifies the gNB as a destination of the model download.

In response to the request, the model server may retrieve the AI model data stored therein, and encapsulate the AI model data in proper PDUs for transfer to the operator network, wherein the AI model data may include the AI model ID, the metadata and the model file as described with reference to FIG. 4. Similar to the process described in FIG. 6, the AI model data is transferred via the UPF of the core network. The CU-UP receives the PDUs carrying the AI model data, extracts the AI model data by decapsulating the PDUs, and stores it locally, for example, in a memory of the modem of the gNB for inference of corresponding use case.

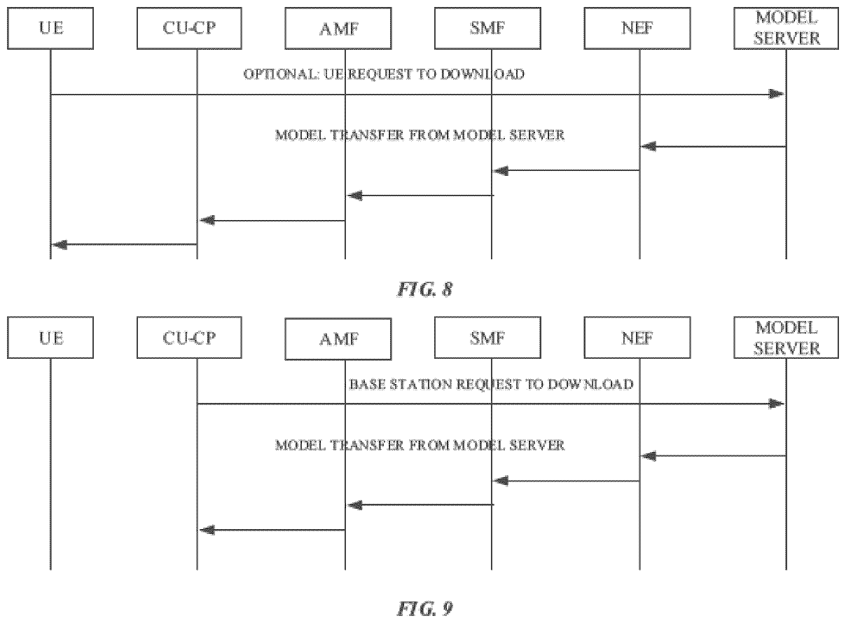

FIG. 8 and FIG. 9 show flowcharts illustrating a second aspect of the model transfer from the model server according to the present application. According to the second aspect, the model transfer is implemented in the control plane of the core network and the access network.

Currently, the control plane of the 5G NR supports only Cellular Internet of Things (CIoT) optimization for exchanging small packets between the UE and the SMF as payload of a Non-Access Stratum (NAS) message. According to the second aspect of the present application, the control plane is enabled to support the AI model transfer, avoiding the establishment of a user plane connection for the PDU Session. The UE and the AMF perform integrity protection and ciphering for the AI model data by using NAS PDU integrity protection and ciphering.

FIG. 8 shows a flowchart of the model transfer to the UE according to the second aspect. As shown in FIG. 8, the model transfer may be triggered by a request from the UE, or by a request from the gNB (not shown). If there is not an available PDU session between the UE and the model server, the SMF may establish a PDU session without the user plane connection.

In response to the request, the model server may retrieve the AI model data stored therein, and encapsulate the AI model data in proper PDUs for transfer to the operator network. According to the second embodiment, the AI model data is transferred via only the control plane. Specifically, the AI model data is transferred to the SMF via a Network Exposure Function (NEF) in the core network. The NEF can provide exposure of capabilities and events, secure provision of information from external application to 3GPP network, retrieval of data from external party, and the like.

The SMF forwards the AI model data to the gNB (i.e., the CU-CP) via the AMF. In the core network, the AI model data may be encapsulated as payload of a NAS message. The CU-CP of the gNB may transfer the AI model data to the UE in PDUs of the AN protocol layers, for example, RRC PDUs in the control plane.

Depending on a size of the AI model data, RRC message segmentation may be required, especially for a large model file. The AI model may be configured as one Information Element (IE) in the RRC message, with associated metadata and model file in a transparent container.

On the UE side, the UE may decapsulate the PDUs, e.g., the RRC PDUs, to obtain the AI model data. The UE may store the obtained AI model data locally, for example, in a memory of its modem for later use.

FIG. 9 shows a flowchart of the model transfer to the gNB according to the second aspect. As shown in FIG. 9, the model transfer may be triggered by a request from the gNB (i.e., the CU-CP) to download the AI model. The request specifies the gNB as a destination of the model download.

Similar to the model transfer depicted in FIG. 8, the AI model data may be transferred to the CU-CP of the gNB via the NEF, the SMF and the AMF in the control plane. The CU-CP receives the PDUs carrying the AI model data, extracts the AI model data by decapsulating the PDUs, and stores it locally, for example, in a memory of the modem of the gNB for inference of corresponding use case.

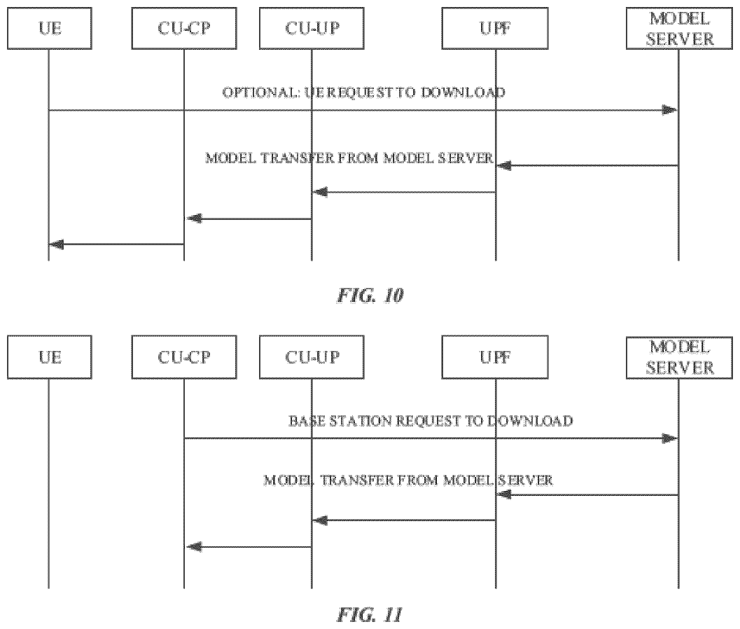

FIG. 10 and FIG. 11 show flowcharts illustrating a third aspect of the model transfer from the model server according to the present application. According to the third embodiment, the model transfer is implemented in the user plane of the core network and the control plane of the access network.

FIG. 10 shows a flowchart of the model transfer to the UE according to the third aspect. As shown in FIG. 10, the model transfer may be triggered by a request from the UE, or by a request from the gNB (not shown). If there is not an available PDU session between the UE and the model server, the SMF may establish a PDU session with the user plane connection.

In response to the request, the model server may retrieve the AI model data stored therein, and encapsulate the AI model data in proper PDUs for transfer to the operator network. The AI model data is transferred to the UPF of the core network via the N6 interface. The CU-UP receives the AI model data from the UPF via the N3 interface, and forwards to the CU-CP of the same gNB via the E1 interface. The CU-CP may encapsulate the AI model data in PDUs of the control plane, for example, RRC PDUs.

Depending on a size of the AI model data, RRC message segmentation may be required. The AI model may be configured as one IE in the RRC message, with associated metadata and model file in a transparent container.

On the UE side, the UE may decapsulate the PDUs, such as the RRC PDUs, to obtain the AI model data. The UE may store the obtained AI model data locally, for example, in a memory of its modem for corresponding use case.

FIG. 11 shows a flowchart of the model transfer to the gNB according to the third aspect. As shown in FIG. 11, the model transfer may be triggered by a request from the gNB. If there is not an available PDU session between the UE and the model server, the SMF may establish a PDU session with the user plane connection.

In response to the request, the model server may transfer the AI model data to the UPF of the core network in proper PDUs via the N6 interface. The CU-UP receives the AI model data from the UPF via the N3 interface, and forwards to the CU-CP of the same gNB via the E1 interface. The CU-CP extracts the AI model data by decapsulating the PDUs, and stores it locally, for example, in a memory of the modem for inference at the gNB.

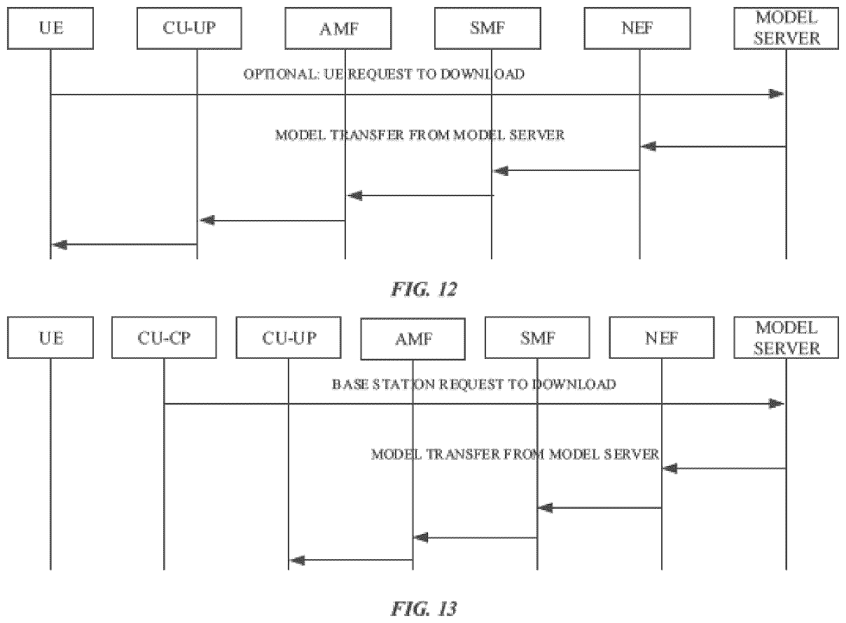

FIG. 12 and FIG. 13 show flowcharts illustrating a fourth aspect of the model transfer from the model server according to the present application. According to the fourth aspect, the model transfer is implemented in the control plane of the core network and the user plane of the access network.

FIG. 12 shows a flowchart of the model transfer to the UE according to the fourth aspect. As shown in FIG. 12, the model transfer may be triggered by a request from the UE, or by a request from the gNB (not shown).

In response to the request, the model server may retrieve the AI model data stored therein, and encapsulate the AI model data in proper PDUs for transfer to the operator network. The AI model data is transferred to the SMF via a Network Exposure Function (NEF) in the core network. The SMF forwards the AI model data to the gNB (i.e., the CU-UP) via the AMF. In the core network, the AI model data may be encapsulated as payload of a NAS message.

The CU-UP of the gNB may transfer the AI model data to the UE in PDUs of the AN protocol layers in the user plane. On the UE side, the UE may decapsulate the PDUs, such as the SDAP PDUs, to obtain the AI model data. The UE may store the obtained AI model data locally, for example, in a memory of its modem for later use.

FIG. 13 shows a flowchart of the model transfer to the gNB according to the fourth aspect. As shown in FIG. 13, the model transfer may be triggered by a request from the gNB.

In response to the request, the model server may retrieve the AI model data stored therein, and encapsulate the AI model data in proper PDUs for transfer to the operator network. The AI model data is transferred to the SMF via a Network Exposure Function (NEF) in the core network. The SMF forwards the AI model data to the gNB (i.e., the CU-UP) via the AMF. In the core network, the AI model data may be encapsulated as payload of a NAS message.

The CU-UP receives the PDUs carrying the AI model data, extracts the AI model data by decapsulating the PDUs, and stores it locally, for example, in a memory of the modem of the gNB for inference of corresponding use case.

2) Model Transfer from Inside of Operator Network

There is a case where the AI model is trained by the operator network itself, and the AI model data may be stored within the operator network. For example, the 5GC provides a network function known as Unified Data Management (UDM), which can provide functions such as generation of 3GPP AKA authentication credentials, SMS management, support of external parameter provisioning (Expected UE Behavior parameters or Network Configurations parameters) and the like. The UDM may store and retrieve subscription data in Unified Data Repository (UDR), and presents its function via a Nudm interface. The 5GC also provides an Unstructured Data Storage Function (UDSF), which can provide storage and retrieval of information as unstructured data by any network function via a Nudsf interface.

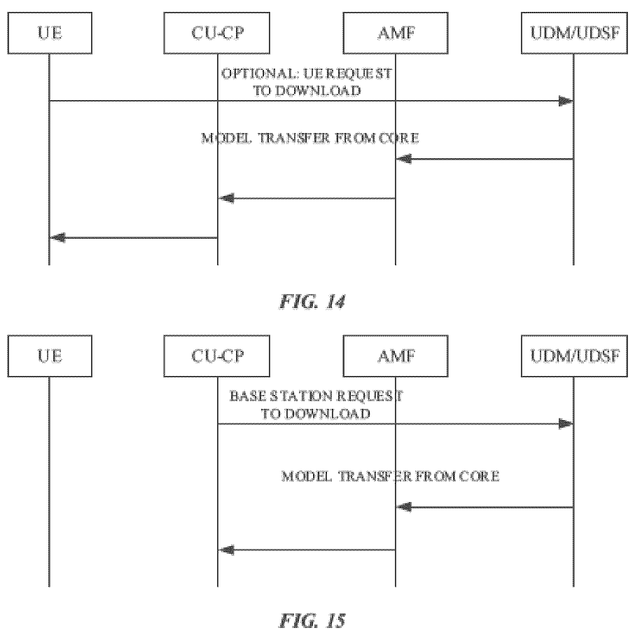

According to a fifth embodiment of the present application, the AI model data may be stored and managed as unified data by the UDM, or may be stored and accessed as unstructured data by the UDSF. FIG. 14 and FIG. 15 show flowcharts illustrating the fifth embodiment of the model transfer from the core network according to the present application. According to the fifth embodiment, the model transfer is implemented in the control plane of the core network and the access network.

FIG. 14 shows a flowchart of the model transfer to the UE according to the fifth embodiment. As shown in FIG. 14, the model transfer may be triggered by a request from the UE, or by a request from the gNB (not shown).

In response to the request, the UDM or UDSF may retrieve the AI model data, and encapsulate the AI model data in proper PDUs for transfer in the control plane. The AI model data may be transferred to the gNB (i.e., the CU-CP) as payload of a NAS message via the AMF.

For transfer to the UE, the CU-CP may encapsulate the AI model data in PDUs of the AN protocol layers, for example, RRC PDUs. Depending on a size of the AI model data, RRC message segmentation may be required. The AI model may be configured as one IE in the RRC message, with associated metadata and model file in a transparent container.

On the UE side, the UE may decapsulate the PDUs, such as the RRC PDUs, to obtain the AI model data. The UE may store the obtained AI model data locally, for example, in a memory of its modem for corresponding use case.

FIG. 15 shows a flowchart of the model transfer to the gNB according to the fifth embodiment. As shown in FIG. 15, the model transfer may be triggered by a request from the gNB.

In response to the request, the UDM or UDSF may retrieve the AI model data, and encapsulate the AI model data in proper PDUs for transfer in the control plane. The AI model data is transferred to the gNB (i.e., the CU-CP) as payload of a NAS message via the AMF.

The CU-CP receives the PDUs carrying the AI model data, extracts the AI model data by decapsulating the PDUs, and stores it locally, for example, in a memory of the modem of the gNB for inference of corresponding use case.

3) Model Transfer from RAN Cloud

The 5G NR or future wireless communication systems may require greater flexibility in building, expanding and deploying telecommunication networks. Cloud technologies offer new and innovative options for such RAN deployments to complement existing proven solutions. Open RAN is a general term in the industry, which refers to an open RAN architecture with open, interoperable interfaces and decoupling of software and hardware. This architecture can bring innovations driven by big data and artificial intelligence to the RAN, which may be improved as “RAN cloud”.

The RAN cloud implements RAN functions through a general-purpose computing platform, rather than a dedicated hardware platform, and manages virtualization of RAN functions based on cloud-native principles. Cloudification of the RAN may start with running certain 5G RAN functions in containers over a common hardware platform, such as the control and user planes in the central unit, and then delay-sensitive wireless processing functions in the distributed unit. Furthermore, the RAN cloud may incorporate some functions of the core network, such as storage management functions, like the UDM and/or UDSF.

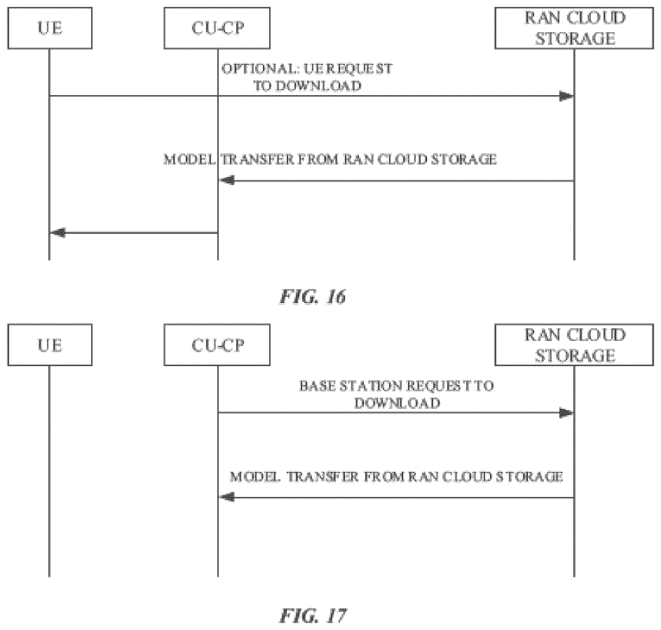

FIG. 16 and FIG. 17 show flowcharts illustrating the sixth embodiment of the model transfer from the RAN cloud according to the present application. According to the sixth embodiment, the model transfer is implemented in the control plane.

FIG. 16 shows a flowchart of the model transfer to the UE according to the sixth embodiment. As shown in FIG. 16, the model transfer may be triggered by a request from the UE, or by a request from the gNB (not shown).

In response to the request, the CU-CP may retrieve the AI model data from RAN cloud storage, which can support retrieval and storage of unified data and/or unstructured data, that is, the RAN cloud storage may have similar functions to the UDM or UDSF. Such retrieval may be implemented by an interface presented by the RAN cloud storage. For transfer to the UE, the CU-CP may encapsulate the AI model data in PDUs of the AN protocol layers, for example, RRC PDUs. Depending on a size of the AI model data, RRC message segmentation may be required. The AI model may be configured as one IE in the RRC message, with associated metadata and model file in a transparent container.

The UE may decapsulate the received PDUs, such as the RRC PDUs, to obtain the AI model data. The UE may store the obtained AI model data locally, for example, in a memory of its modem for corresponding use case.

FIG. 17 shows a flowchart of the model transfer to the gNB according to the sixth embodiment. As shown in FIG. 17, the model transfer may be triggered by a request from the gNB.

In response to the request, the CU-CP may retrieve the AI model data from the RAN cloud storage on the RAN cloud, for example via an interface presented by the RAN cloud storage. The CU-CP receives the PDUs carrying the AI model data, extracts the AI model data by decapsulating the PDUs, and stores it locally, for example, in a memory of the modem of the gNB for inference of corresponding use case.

### Example Method

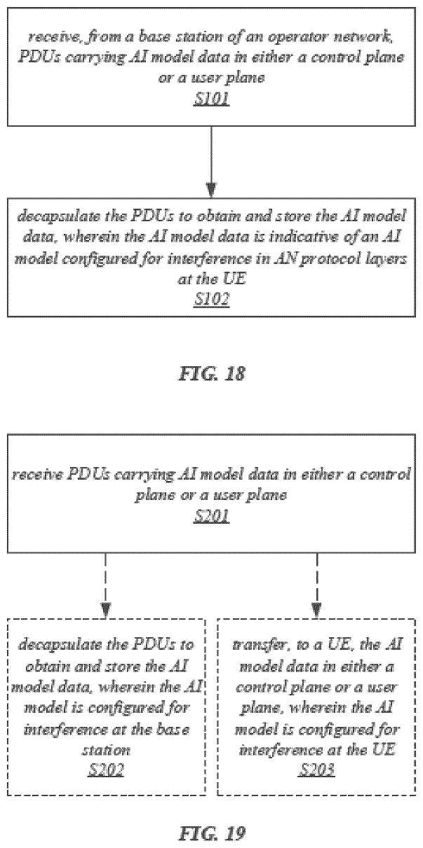

FIG. 18 is a flowchart diagram illustrating an example method for supporting the AI model transfer according to the embodiments of the present application. The method may be carried out at a UE.

At S101, the UE receives, from a base station of an operator network, PDUs carrying AI model data in the user plane, as shown in FIG. 6 and FIG. 12, or in the control plane, as shown in FIGS. 8, 10, 14 and 16. The PDUs may be RRC PDUs in the control plane or SDAP PDUs in the user plane.

At S102, the UE decapsulates the PDUs to obtain and store the AI model data, wherein the AI model data is indicative of an AI model configured for inference in AN protocol layers at the UE.

FIG. 19 is a flowchart diagram illustrating an example method for supporting the AI model transfer according to the embodiments of the present application. The method may be carried out at a base station, such as a gNB.

At S201, the base station receives PDUs carrying AI model data in the user plane, as shown in FIGS. 6-7 and 10-11, or in the control plane, as shown in FIGS. 8-9 and 12-17. The PDUs may be RRC PDUs in the control plane or SDAP PDUs in the user plane.

Optionally, If the AI model data is indicative of an AI model for inference at the base station itself, at S202, the base station decapsulates the PDUs to obtain the store the AI model data.

If the AI model data is indicative of an AI model for inference at a UE, at S203, the base station transfers the AI model data to the UE in the user plane, as shown in FIG. 6 and FIG. 12, or in the control plane, as shown in FIGS. 8, 10, 14 and 16.

Embodiments contemplated herein include an apparatus comprising means to perform one or more elements of the method as shown in FIG. 18. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 18. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method as shown in FIG. 18. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 18. This apparatus may be, for example, an apparatus of a UE (such as a wireless device 202 that is a UE, as described herein).

Embodiments contemplated herein include a signal as described in or related to one or more elements of the method as shown in FIG. 18.

Embodiments contemplated herein include a computer program or computer program product comprising instructions, wherein execution of the program by a processor is to cause the processor to carry out one or more elements of the method as shown in FIG. 18. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method as shown in FIG. 19. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 19. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method as shown in FIG. 19. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 19. This apparatus may be, for example, an apparatus of a base station (such as a network device 218 that is a base station, as described herein).

Embodiments contemplated herein include a signal as described in or related to one or more elements of the method as shown in FIG. 19.

Embodiments contemplated herein include a computer program or computer program product comprising instructions, wherein execution of the program by a processing element is to cause the processing element to carry out one or more elements of the method as shown in FIG. 19. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

### EXAMPLE SECTION

The following examples pertain to further embodiments.

Example 1 may include an apparatus of a user equipment (UE), the apparatus comprising a processor, and a memory storing instructions that, when executed by the processor, configure the apparatus to: receive, from a base station of an operator network, Protocol Data Units (PDUs) carrying Artificial Intelligence (AI) model data in either a control plane or a user plane, and decapsulate the PDUs to obtain and store the AI model data, wherein the AI model data is indicative of an AI model configured for inference in Access Network (AN) protocol layers at the UE.

Example 2 may include the apparatus of Example 1, wherein the AI model data originates from a server outside of the operator network, and is transferred to the base station via a core network of the operator network in either the control plane or in the user plane.

Example 3 may include the apparatus of Example 1, wherein the AI model data originates from a core network of the operator network, and is transferred to the based station in the control plane.

Example 4 may include the apparatus of Example 1, wherein the AI model data originates from a Radio Access Network (RAN) cloud of the operator network, and is accessed by the base station in the control plane.

Example 5 may include the apparatus of Example 1, wherein the PDUs are Radio Resource Control (RRC) PDUs in the control plane, or Service Data Adaptation Protocol (SDAP) PDUs.

Example 6 may include the apparatus of Example 1, wherein the AI model data is transferred in response to a request from the UE or a request from the base station.

Example 7 may include the apparatus of Example 1, wherein the AI model is a one-sided model or a part of a two-sided model which performs inference at the UE.

Example 8 may include the apparatus of Example 1, wherein the AI model data includes AI model ID identifying the AI model, metadata describing the AI model, and a model file storing the AI model.

Example 9 may include the apparatus of Example 8, wherein the AI model ID includes one or more of UE vendor identification, network device vendor identification, PLMN ID of the operator network, Use case ID, and model number for the use case.

Example 10 may include the apparatus of Example 8, wherein the model file is reformatted to be applicable to the UE by one of a server outside the operator network, a core network in the operator network, or the base station.

Example 11 may include the apparatus of Example 8, wherein the metadata describes one or more of the following: training status of the AI model; functionality/object, input/output of the AI model; latency benchmarks, memory requirements, accuracy of the AI model; compression status of the AI model; inferencing/operating condition of the AI model; and pre-processing and post-processing of measurement for input/output of the AI model.

Example 12 may include an apparatus in a base station of an operator network, the apparatus comprising a processor, and a memory storing instructions that, when executed by the processor, configure the apparatus to: receive Protocol Data Units (PDUs) carrying Artificial Intelligence (AI) model data in either a control plane or a user plane, wherein the AI model data is indicative of an AI model configured for inference in Access Network (AN) protocol layers at the base station or at a UE.

Example 13 may include the apparatus of Example 12, wherein the AI model data originates from a server outside of the operator network, and is transferred to the base station via a core network of the operator network in the control plane or in the user plane.

Example 14 may include the apparatus of Example 12, wherein the AI model data originates from a core network of the operator network, and is transferred to the based station in the control plane.

Example 15 may include the apparatus of Example 12, wherein the AI model data originates from a Radio Access Network (RAN) cloud of the operator network, and is accessed by the base station in the control plane.

Example 16 may include the apparatus of Example 12, wherein the instructions that, when executed by the processor, further configure the apparatus to:
decapsulate the PDUs to obtain and store the AI model data, wherein the AI model is configured for inference at the base station.

Example 17 may include the apparatus of Example 12, wherein the instructions that, when executed by the processor, further configure the apparatus to: transfer, to a UE, the AI model data in either a control plane or a user plane, wherein the AI model is configured for inference at the UE.

Example 18 may include the apparatus of Example 12, wherein the AI model data is transferred to the UE in Radio Resource Control (RRC) PDUs or in Service Data Adaptation Protocol (SDAP) PDUs.

Example 19 may include the apparatus of Example 16, wherein the AI model is a one-sided model or a part of a two-sided model which performs inference at the base station.

Example 20 may include the apparatus of Example 12, wherein the AI model data includes AI model ID indicative of the AI model, metadata describing the AI model, and a model file storing the AI model.

Example 21 may include the apparatus of Example 20, wherein the AI model ID includes one or more of UE vendor identification, network device vendor identification, PLMN ID of the operator network, Use case ID, and model number for the use case.

Example 22 may include the apparatus of Example 20, wherein the model file is reformatted to be applicable to the UE by one of a server outside the operator network, a core network in the operator network, or the base station.

Example 23 may include the apparatus of Example 20, wherein the metadata describes one or more of the following: training status of the AI model; functionality/object, input/output of the AI model; latency benchmarks, memory requirements, accuracy of the AI model; compression status of the AI model; inferencing/operating condition of the AI model; and pre-processing and post-processing of measurement for input/output of the AI model.

Example 24 may include an apparatus in a core network of an operator network, the apparatus comprising a processor, and a memory storing instructions that, when executed by the processor, configure the apparatus to: transfer, to a base station, Protocol Data Units (PDUs) carrying Artificial Intelligence (AI) model data in either a control plane or a user plane, wherein the AI model data is indicative of an AI model configured for inference in Access Network (AN) protocol layers at the UE or at the base station.

Example 25 may include the apparatus of Example 24, wherein the AI model data originates from a server outside of the operator network, and is transferred to the base station via a core network of the operator network in the control plane or in the user plane.

Example 26 may include the apparatus of Example 24, wherein the AI model data originates from the core network of the operator network, and is transferred to the based station in the control plane.

Example 27 may include the apparatus of Example 24, wherein the AI model data includes AI model ID indicative of the AI model, metadata describing the AI model, and a model file storing the AI model.

Example 28 may include the apparatus of Example 27, wherein the instructions that, when executed by the processor, further configure the apparatus to: reformat the model file to be applicable to the UE or the base station.

Example 29 may include an apparatus, the apparatus comprising a processor, and a memory storing instructions that, when executed by the processor, configure the apparatus to: assign a unique model ID to an Artificial Intelligence (AI) model; generate metadata for describing the AI model; and store the AI model in association with the model ID and the metadata.

Example 30 may include the apparatus of Example 29, wherein the AI model ID includes one or more of UE vendor identification, network device vendor identification, PLMN ID of the operator network, Use case ID, and model number for the use case.

Example 31 may include the apparatus of Example 29, wherein the metadata describes one or more of the following: training status of the AI model; functionality/object, input/output of the AI model; latency benchmarks, memory requirements, accuracy of the AI model; compression status of the AI model; inferencing/operating condition of the AI model; and pre-processing and post-processing of measurement for input/output of the AI model.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE), the apparatus comprising:
a processor; and
a memory storing instructions that, when executed by the processor, cause the UE to:
receive from a base station of an operator network, Protocol Data Units (PDUs) carrying Artificial Intelligence (AI) model data; and
decapsulate the PDUs to obtain and store the AI model data, wherein the AI model data is indicative of an AI model configured for inference in Access Network (AN) protocol layers at the UE,
wherein a unique AI model ID is assigned to the AI model globally across the operator network and other operator networks.

2. The apparatus of claim 1, wherein the AI model data originates from a server outside of the operator network, and is transferred to the base station via a core network of the operator network in either a control plane or a user plane.

3. The apparatus of claim 1, wherein the AI model data originates from a core network of the operator network, and is transferred to the UE via a user plane.

4. The apparatus of claim 1, wherein the AI model data originates from a Radio Access Network (RAN) cloud of the operator network, and is transferred to the UE in a user plane.

5. The apparatus of claim 1, wherein the PDUs are Radio Resource Control (RRC) PDUs in a control plane, or Service Data Adaptation Protocol (SDAP) PDUs.

6. The apparatus of claim 1, wherein the AI model data is transferred in response to a request from the UE or a request from the base station.

7. The apparatus of claim 1, wherein the AI model is a one-sided model or a part of a two-sided model which performs inference at the UE.

8. The apparatus of claim 1, wherein the unique AI model ID is provided by a specification.

9. The apparatus of claim 8, wherein the AI model ID includes one or more of UE vendor identification, network device vendor identification, PLMN ID of the operator network, Use case ID, and model number for a use case.

10. An apparatus in a base station of an operator network, the apparatus comprising:
a processor; and
a memory storing instructions that, when executed by the processor, cause the base station to:
receive Protocol Data Units (PDUs) carrying Artificial Intelligence (AI) model data in either a control plane or a user plane,
wherein the AI model data is indicative of an AI model configured for inference in Access Network (AN) protocol layers at the base station or at a UE.

11. The apparatus of claim 10, wherein the AI model data originates from a core network of the operator network, and is transferred to the based station in the control plane.

12. The apparatus of claim 10, wherein the AI model data originates from a Radio Access Network (RAN) cloud of the operator network, and is accessed by the base station in the control plane.

13. The apparatus of claim 10, wherein the instructions that, when executed by the processor, further configure the apparatus to:
decapsulate the PDUs to obtain and store the AI model data, wherein the AI model is configured for inference at the base station.

14. The apparatus of claim 10, wherein the instructions that, when executed by the processor, further configure the apparatus to:
transfer, to a UE, the AI model data in either a control plane or a user plane, wherein the AI model is configured for inference at the UE.

15. The apparatus of claim 14, wherein the AI model data is transferred to the UE in Radio Resource Control (RRC) PDUs or in Service Data Adaptation Protocol (SDAP) PDUs.

16. The apparatus of claim 10, wherein the AI model data includes AI model ID indicative of the AI model, metadata describing the AI model, and a model file storing the AI model.

17. The apparatus of claim 16, wherein the model file is reformatted to be applicable to the UE by one of a server outside the operator network, a core network in the operator network, or the base station.

18. The apparatus of claim 16, wherein the metadata describes one or more of the following:
training status of the AI model;
functionality/object, input/output of the AI model;
latency benchmarks, memory requirements, accuracy of the AI model;
compression status of the AI model;
inferencing/operating condition of the AI model; and
pre-processing and post-processing of measurement for input/output of the AI model.

19-23. (canceled)

24. An apparatus, the apparatus comprising:
a processor; and
a memory storing instructions that, when executed by the processor, cause the apparatus to:
assign a unique model ID to an Artificial Intelligence (AI) model;
generate metadata for describing the AI model; and
store the AI model in association with the model ID and the metadata.

25. The apparatus of claim 24,
wherein the AI model ID includes one or more of UE vendor identification, network device vendor identification, PLMN ID of an operator network, Use case ID, and model number for a use case, and
wherein the metadata describes one or more of the following:
training status of the AI model;
functionality/object, input/output of the AI model;
latency benchmarks, memory requirements, accuracy of the AI model;
compression status of the AI model;
inferencing/operating condition of the AI model; and
pre-processing and post-processing of measurement for input/output of the AI model.
